(19) United States
(12) Patent Application Publication
(10) Pub. No.: US 2006/0257052 A1
(43) Pub. Date: Nov. 16, 2006

(54) Method for image adjustment

(75) Inventors: Yu-Min Chang, Taipei (TW); Hsiang-Chun Lin, Taipei (TW)

Correspondence Address: BIRCH STEWART KOLASCH & BIRCH, PO BOX 747, FALLS CHURCH, VA, 22040-0747, US

(73) Assignee: Asmedia Technology Inc.

(21) Appl. No.: 11/429,271

(22) Filed: May 8, 2006

(30) Foreign Application Priority Data
May 10, 2005 (TW) 94115125

(51) Int. Cl. G06K 9/32; G06K 9/40

(52) U.S. Cl. 382/300; 382/254

(57) ABSTRACT

The present invention discloses a method for image adjustment and includes the following steps. First, an image is supplied. The image includes many first sampling pixels in a high frequency area. Then, at least an interpolation algorithm is used on the image to obtain a first interpolation curve. Afterwards, the first interpolation curve in the high frequency area is modified to acquire a second interpolation curve. Then, according to the second interpolation curve, pixels are interpolated into the image.

### RELATED APPLICATIONS

The present application is based on, and claims priority from, Taiwan Application Serial Number 94115125, filed May 10, 2005, the disclosure of which is hereby incorporated by reference herein in its entirety.

### FIELD OF THE INVENTION

The present invention relates to a method for image adjustment, and more particularly, to a method for image adjustment used to adjust the graininess caused by the image enlargement algorithms in an image.

### BACKGROUND OF THE INVENTION

By the coming optical and digital time, the image data information plays an important key in daily life. Since the digital image has the characteristics of easy keep, transmittal, modification, and low cost, it is widely utilized in various fields. And the image processing technique becomes more and more important now.

The most-used image processing techniques are image enlargement and image shrinking. Image shrinking decreases the number of pixels in the image and is achieved by conserving the important characteristics of the image. Image enlargement, however, increases the number of pixels in the image. That is, part of the image needs to be reestablished. The deficient part needs to be filled according to the available information. Hence, how to obtain the best result in image enlargement has been a major issue in recent years.

In conventional image enlargement techniques, interpolation algorithms are usually used to acquire enlarged images. When low-level interpolation algorithms are used, if the difference between two adjacent pixels is more obvious (sharper), the inserted pixel value will be improper since fewer pixels are sampled, which results in disharmony within frames. If high-level interpolation algorithms are used, more pixels are sampled, so better results can be obtained in areas with greater differences between two pixels. However, the interpolation curve derived from the high-level interpolation algorithms causes two minimum values near the two pixels, which makes the inserted pixel values smaller than the original pixel values nearby. The interpolation results obtained under such conditions will cause graininess in the image, especially on edges and corners which are sharper in the image. In other words, extra lines or shadows will appear in high frequency areas in the image where there are more variations. This is because the inserted pixel values derived from the interpolation algorithms are located in high frequency areas, and the inserted pixel values lack further processing.

Reference is made to FIG. 1 illustrating the conventional image enlarging method. In FIG. 1, the pixel 102, the pixel 104, the pixel 106 and the pixel 108 are four pixels in an image. The x-axis coordinate represents the position of the image in which the right side corresponds to the right side of the image. The y-axis coordinate represents the magnitude of the pixel value in which the pixel values increase moving upward along the axis. It is shown from the image that the pixel values of the pixel 102 and the pixel 104 are approximate and the pixel values of the pixel 106 and the pixel 108 are approximate. Therefore, the images of the pixel 102 and the pixel 104 are similar, and the images of the pixel 106 and the pixel 108 are similar. Contrarily, there is an obvious difference between the pixel values of the pixel 104 and the pixel 106, meaning the image has greater variation there and is considered a high frequency area.

Assuming the pixel 102, the pixel 104, the pixel 106 and the pixel 108 are all in the high frequency area, after using the interpolation algorithms with the pixel 102, the pixel 104, the pixel 106 and the pixel 108 to get the enlarged image, multiple inserted pixel values located on the curve in FIG. 1, the pixel values of the pixel 110, the pixel 112, the pixel 114 and the pixel 116, are acquired. As seen in FIG. 1, the pixel value of the pixel 110 between the pixel 102 and the pixel 104 is smaller than those of the pixel 102 and the pixel 104, the pixel value of the pixel 114 is greater than those of the pixel 106 and the pixel 108, and the pixel value of the pixel 116 at the right side of the pixel 108 is smaller than that of the pixel 108. Since the pixel 110, the pixel 112, the pixel 114 and the pixel 116 are all in the high frequency area and their pixel values are not further adjusted, the inserted pixel values in the high frequency area cause graininess in the image.

### SUMMARY OF THE INVENTION

Therefore, one objective of the present invention is to provide a method for image adjustment to resolve the graininess of the image.

Another objective of the present invention is to provide a method for image adjustment, which is especially suitable for resolving the graininess of the image after using a high-frequency algorithm to enlarge the image.

Still another objective of the present invention is to provide a method for image adjustment by limiting the range of inserted pixel values derived from the interpolation algorithms to resolve the graininess of the image.

According to the aforementioned objectives, the present invention provides a method for image adjustment including the following steps. First, an image is supplied. The image includes multiple first sampling pixels in a high frequency area. Then, at least an interpolation algorithm is used on the image to obtain a first interpolation curve. Afterwards, the first interpolation curve in the high frequency area is modified to acquire a second interpolation curve. Then, according to the second interpolation curve, at least an inserted pixel value is interpolated into the image.

According to the preferred embodiment of the present invention, the step of modifying the first interpolation curve in the high frequency area to acquire the second interpolation curve includes replacing at least an inserted pixel value of the first interpolation curve in the high frequency area with a smallest value of the first sampling pixels nearby when the inserted pixel value of the first interpolation curve in the high frequency area is smaller than the smallest value of the first sampling pixels nearby. Moreover, the abovementioned modifying step further includes replacing at least an inserted pixel value of the first interpolation curve in the high frequency area with a largest value of the first sampling pixels nearby when the inserted pixel value of the first interpolation curve in the high frequency area is greater than the largest value of the first sampling pixels nearby. The interpolation algorithm is a high-frequency algorithm and/or a low-frequency algorithm. The high-frequency algorithm may be Lanczos2 algorithm, Lanczos3 algorithm, or Mitchell algorithm. The low-frequency algorithm may be Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm, Gaussian algorithm, or Sinc algorithm.

According to another objective, the present invention provides a method for image adjustment including the following steps. First, an image is supplied. The image includes many first sampling pixels in a high frequency area. Then, at least an interpolation algorithm is used to the image to obtain a first interpolation curve. Afterwards, the first interpolation curve in the high frequency area is modified to acquire a second interpolation curve. When at least an inserted pixel value of the first interpolation curve in the high frequency area is smaller than a smallest value of the first sampling pixels nearby, the inserted pixel value of the first interpolation curve in the high frequency area is replaced with the smallest value of the first sampling pixels nearby; and when the inserted pixel value of the first interpolation curve in the high frequency area is greater than a largest value of the first sampling pixels nearby, the inserted pixel value of the first interpolation curve in the high frequency area is replaced with the largest value of the first sampling pixels nearby. Then, according to the second interpolation curve, inserted pixels are interpolated into the image.

According to the preferred embodiment of the present invention, the interpolation algorithm is a high-frequency algorithm and/or a low-frequency algorithm. According to the preferred embodiment of the present invention, the high- and low-frequency algorithms are selected from those described in the preceding embodiment.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates the conventional image enlarging method;

FIG. 2 illustrates a flow chart according to the preferred embodiment of the present invention;

FIG. 3 illustrates a first interpolation curve according to the preferred embodiment of the present invention;

FIG. 4 illustrates a second interpolation curve according to the preferred embodiment of the present invention; and

FIG. 5 illustrates another interpolation curve according to another embodiment of the present invention.

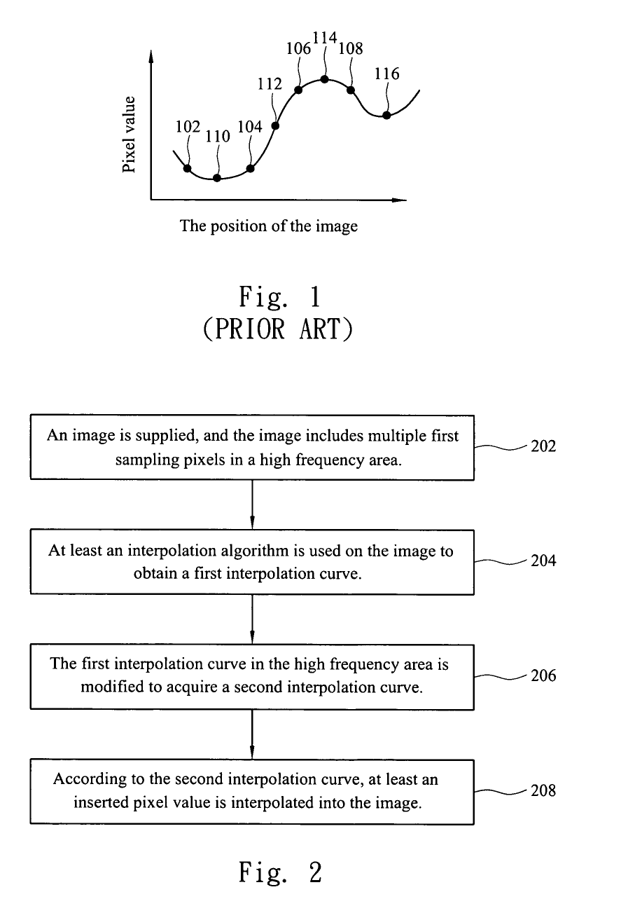

### DETAILED DESCRIPTION OF THE PREFERRED EMBODIMENT

In order to make the illustration of the present invention more explicit and complete, the following description is stated with reference to FIGS. 2 to 5.

Reference is made to FIG. 2, illustrating a flow chart according to the preferred embodiment of the present invention. First, an image is supplied in step 202. The image includes multiple first sampling pixels in a high frequency area. Then, at least an interpolation algorithm is used on the abovementioned image to obtain a first interpolation curve in step 204. The interpolation algorithm is a high-frequency algorithm and/or a low-frequency algorithm. The high-frequency algorithm may be Lanczos2 algorithm, Lanczos3 algorithm, or Mitchell algorithm. The low-frequency algorithm may be Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm, Gaussian algorithm, or Sinc algorithm. The method for image adjustment of the present invention is especially suitable for adjusting the image after using the high-frequency algorithm.

Afterwards, the first interpolation curve in the high frequency area is modified to acquire a second interpolation curve as shown in step 206. The modifying step is to replace the first interpolation curve in the high frequency area with the first sampling pixels. Then, according to the second interpolation curve, at least an inserted pixel value is interpolated into the image in step 208.

Hence, a feature of the present invention is that in the method for image adjustment in the preferred embodiment, after computing the inserted pixel values needed in the image by the interpolation algorithm, the range of the inserted pixel values in the high frequency area are limited and the exceedingly big and the exceedingly small inserted pixel values are deleted to decrease the graininess of the image.

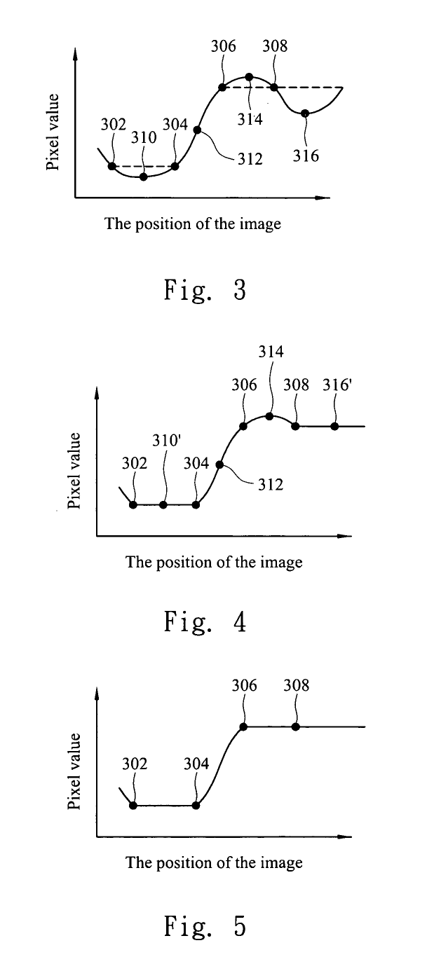

Reference is then made to FIG. 3, illustrating the first interpolation curve according to the preferred embodiment of the present invention. The pixel 302, the pixel 304, the pixel 306 and the pixel 308 are four pixels in an image. The x-axis coordinate represents the position of the image in which the right side, corresponds to the right side of the image. The y-axis coordinate represents the magnitude of the pixel value in which the pixel value increases moving upward along the axis. According to FIG. 3, the pixel values of the pixel 302 and the pixel 304 are approximate and the pixel values of the pixel 306 and the pixel 308 are approximate. Therefore, the images of the pixel 302 and the pixel 304 are similar and the images of the pixel 306 and the pixel 308 are similar. Contrarily, there is an obvious difference between the pixel values of the pixel 304 and the pixel 306, meaning that the image has greater variation there. Furthermore, in the preferred embodiment of the present invention, the pixel 302, the pixel 304 and the right side of the pixel 308 are assumed to be in the high frequency area, and the pixel 306 and the pixel 308 are assumed to be in the low frequency area.

Then, at least an interpolation algorithm is used on the image to compute the inserted pixel value needed in enlarging the image. Therefore, in the preferred embodiment of the present invention, after using the interpolation algorithm with the pixel 302, the pixel 304, the pixel 306 and the pixel 308 to enlarge the image, a first interpolation curve is obtained as the line shown in FIG. 3. The inserted pixel values acquired may be the pixel values of the pixel 310, the pixel 312, the pixel 314 and the pixel 316.

As shown in FIG. 3, the pixel value of the pixel 310 between the pixel 302 and the pixel 304 is smaller than the pixel values of the pixel 302 and the pixel 304, the pixel value of the pixel 314 is greater than the pixel values of the pixel 306 and the pixel 308, and the pixel value of the pixel 316 to the right of the pixel 308 is smaller than the pixel value of the pixel 308. Furthermore, since the pixel 302, the pixel 304 and the right side of the pixel 308 are in the high frequency area and the pixel 306 and the pixel 308 are in the low frequency area, the pixel 310 and the pixel 316 in the high frequency area need to be adjusted and the pixel 314 in the low frequency area does not need further adjustment.

Since the pixel values of the pixel 302 and the pixel 304 are approximate, the images of the pixel 302 and the pixel 304 are similar. Therefore, the inserted pixel value of the pixel 310 is replaced with the pixel value of the pixel 302 or the pixel 304 to be interpolated into the image during enlarging the image. Similarly, the inserted pixel value of the pixel 316 is replaced with the pixel value of the pixel 308 to be interpolated into the image. In the low frequency area, such as the area of the pixel 306 and the pixel 308, the first interpolation curve is used as the final result to avoid flaws in the smooth area. Therefore, there is no adjustment to the pixel 314. After the adjustments, a second interpolation curve is then obtained as shown in FIG. 4.

Furthermore, in other embodiments of the present invention, if the pixel 302, the pixel 304, the pixel 306 and the pixel 308 are all in the high frequency area, the inserted pixel values acquired, the pixel 310, the pixel 314 and the pixel 316, need to be adjusted. The interpolation curve obtained is shown in FIG. 5.

According to the aforementioned description, the present invention has various advantages. For example, in the method for image adjustment in the present invention, the range of the inserted pixel values in the high frequency area obtained by the interpolation algorithm is limited and the exceedingly big and the exceedingly small inserted pixel values are omitted to resolve the graininess of the image.

As is understood by a person skilled in the art, the foregoing preferred embodiments of the present invention are illustrative of the present invention rather than limiting of the present invention. It is intended that various modifications and similar arrangements are included within the spirit and scope of the appended claims, the scope of which should be accorded the broadest interpretation so as to encompass all such modifications and similar structure.

What is claimed is:

1. A method for image adjustment, comprising:
supplying an image, wherein the image comprises a plurality of first sampling pixels in a high frequency area;
using at least an interpolation algorithm on the image to obtain a first interpolation curve;
modifying the first interpolation curve in the high frequency area to acquire a second interpolation curve; and
according to the second interpolation curve, interpolating at least an inserted pixel value into the image.

2. The method for image adjustment according to claim 1, wherein the step of modifying the first interpolation curve in the high frequency area to acquire the second interpolation curve comprises:
when at least an inserted pixel value of the first interpolation curve in the high frequency area is smaller than a smallest value of the first sampling pixels nearby, replacing the inserted pixel value of the first interpolation curve in the high frequency area with the smallest value of the first sampling pixels nearby.

3. The method for image adjustment according to claim 1, wherein the step of modifying the first interpolation curve in the high frequency area to acquire the second interpolation curve comprises:
when at least an inserted pixel value of the first interpolation curve in the high frequency area is greater than a largest value of the first sampling pixels nearby, replacing the inserted pixel value of the first interpolation curve in the high frequency area with the largest value of the first sampling pixels nearby.

4. The method for image adjustment according to claim 1, wherein the interpolation algorithm is a high-frequency algorithm.

5. The method for image adjustment according to claim 4, wherein the high-frequency algorithm is Lanczos2 algorithm, Lanczos3 algorithm, or Mitchell algorithm.

6. The method for image adjustment according to claim 1, wherein the interpolation algorithm is a low-frequency algorithm.

7. The method for image adjustment according to claim 6, wherein the low-frequency algorithm is Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm, Gaussian algorithm, or Sinc algorithm.

8. The method for image adjustment according to claim 1, wherein the interpolation algorithm is a low-frequency algorithm and a high-frequency algorithm.

9. The method for image adjustment according to claim 8, wherein the low-frequency algorithm is Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm, Gaussian algorithm, or Sinc algorithm.

10. The method for image adjustment according to claim 8, wherein the high-frequency algorithm is Lanczos2 algorithm, Lanczos3 algorithm, or Mitchell algorithm.

11. A method for image adjustment, comprising:
supplying an image, wherein the image comprises a plurality of first sampling pixels in a high frequency area;
using at least an interpolation algorithm on the image to obtain a first interpolation curve;
modifying the first interpolation curve in the high frequency area to acquire a second interpolation curve, wherein when at least an inserted pixel value of the first interpolation curve in the high frequency area is smaller than a smallest value of the first sampling pixels nearby, replace the inserted pixel value of the first interpolation curve in the high frequency area with the smallest value of the first sampling pixels nearby, and when the inserted pixel value of the first interpolation curve in the high frequency area is greater than a largest value of the first sampling pixels nearby, replace the inserted pixel value of the first interpolation curve in the high frequency area with the largest value of the first sampling pixels nearby; and
according to the second interpolation curve, interpolating at least an inserted pixel value into the image.

12. The method for image adjustment according to claim 11, wherein the interpolation algorithm is a high-frequency algorithm.

13. The method for image adjustment according to claim 12, wherein the high-frequency algorithm is Lanczos2 algorithm, Lanczos3 algorithm, or Mitchell algorithm.

14. The method for image adjustment according to claim 11, wherein the interpolation algorithm is a low-frequency algorithm.

15. The method for image adjustment according to claim 14, wherein the low-frequency algorithm is Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm, Gaussian algorithm, or Sinc algorithm.

16. The method for image adjustment according to claim 11, wherein the interpolation algorithm is a low-frequency algorithm and a high-frequency algorithm.

17. The method for image adjustment according to claim 16, wherein the low-frequency algorithm is Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm, Gaussian algorithm, or Sinc algorithm.

18. The method for image adjustment according to claim 16, wherein the high-frequency algorithm is Lanczos2 algorithm, Lanczos3 algorithm, or Mitchell algorithm.
